(19) United States
(12) Patent Application Publication
(10) Pub. No.: US 2009/0071866 A1
(43) Pub. Date: Mar. 19, 2009

(54) Portable thermal document binding machine

(76) Inventor: Cornelius Chow, Chula Vista, CA (US)

Correspondence Address: HARRY V. MCGAHEY JR., 1532 SIXTH AVENUE, SAN DIEGO, CA, 92101, US

(21) Appl. No.: 11/900,966

(22) Filed: Sep. 13, 2007

(51) Int. Cl. B42C 9/00; B42C 19/00; B65D 69/00

(52) U.S. Cl. 206/576; 412/37; 412/6

(57) ABSTRACT

A portable thermal document binding machine which uses a strip of thermal hot melt material melted by a heating element, which is then cooled by a cooling element to use gravity to securely seal the documents being bound. A portable trimming board and thermal strip trimmer are used to finish the binding process.

### CROSS-REFERENCE TO RELATED APPLICATIONS

Not Applicable.

### STATEMENT REGARDING FEDERALLY SPONSORED RESEARCH FOR DEVELOPMENT:

No Federal Funds were used in the development of this Invention.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC.

Not Applicable.

### BACKGROUND OF THE INVENTION

There is a great need for a portable thermal bookbinding machine which is as effective as the stationary thermal bookbinding machines now on the market. The invention herein disclosed meets that need in a very effective way. There are other thermal bookbinding systems but portability has heretofore been limited.

### FIELD OF THE INVENTION

Thermal bookbinding machine.

### DESCRIPTION OF RELATED ART

Historical attempts to address some or all of the limitations in prior patented binding machines have been numerous. Examples of relevant art from U.S. Patents are U.S. Pat. Nos. 5,536,044, 5,152,654, 4,385,225, 4,178,201, 4,149,829, 4,141,100, 6,986,631, 6,732,777, 6,641,345, 6,619,900, 5,536,044, 5,536,044, 5,346,350, 5,31,6424, 5,035,561, 4,187,571 and U.S. patent application Ser. No. 4800110. None of these are portable machines as capable of creating high quality bindings of documents as the subject invention.

### BRIEF SUMMARY OF THE INVENTION

This improved thermal document binding machine is designed for the portable binding of documents using thermal heat to melt a hot melt material over the binding, thereby sealing the pages therein.

### BRIEF DESCRIPTION OF THE SEVERAL VIEWS OF THE DRAWINGS

FIG. 1 shows a perspective view of an assembled Binding Machine without the Document Stacking Base Housing which can also be used with it.

FIG. 2 shows an exploded perspective view of the machine with the Left Frame Cover removed and a stack of documents ready to bind in it.

FIG. 3A shows a perspective view of a stack of documents in the Document Stacking Base Housing anchored together with the Paper Clamp.

FIG. 3B shows a perspective view of a stack of documents in the Paper Clamp after removal from the Document Stacking Base Housing.

FIG. 4 shows an exploded perspective view of the machine with a stack of documents already in the Paper Clamp about to be inserted into the Binding Machine.

FIG. 5 shows a perspective view of the machine with the Thermal Strip placed on the spine of the document about to be heated by the Heater Element.

FIG. 6 shows a perspective view of the machine with the Heater Element in the closed position over the Hot Strip Material.

FIG. 7 shows a perspective view of the Heater Element in the open position with the Cooling Element in place over the Hot Melt Strip.

FIG. 8A shows a perspective view of the bound document removed from the Binding Machine. At that point in the binding process the excess Hot Melt Thermal Strip is cut off or broken off from both sides of the document being bound.

FIG. 8B shows a close up perspective view of the Thermal Strip Trimmer in use to trim off the excess of the Thermal Strip composed of the Hot Melt Material after binding.

FIG. 9A shows a bound document in the Document Holder with Binding Tape or clear “Magic” Tape applied to the spine.

FIG. 9B shows a bound document pushed down into the Document Stacking Base Housing to fold down the Binding Tape or clear “Magic” Tape applied previously to the spine of the document.

FIG. 10: Shows a close up perspective view of the Thermal Strip Trimmer used to trim off the excess of the Thermal Strip composed of the Hot Melt material after binding.

FIG. 11 shows a bound document ready for use.

FIG. 12 shows a perspective view of another embodiment of the invention using a motor means to open and close the heating and cooling Elements instead of hand actuated levers.

### DETAILED DESCRIPTION OF THE INVENTION

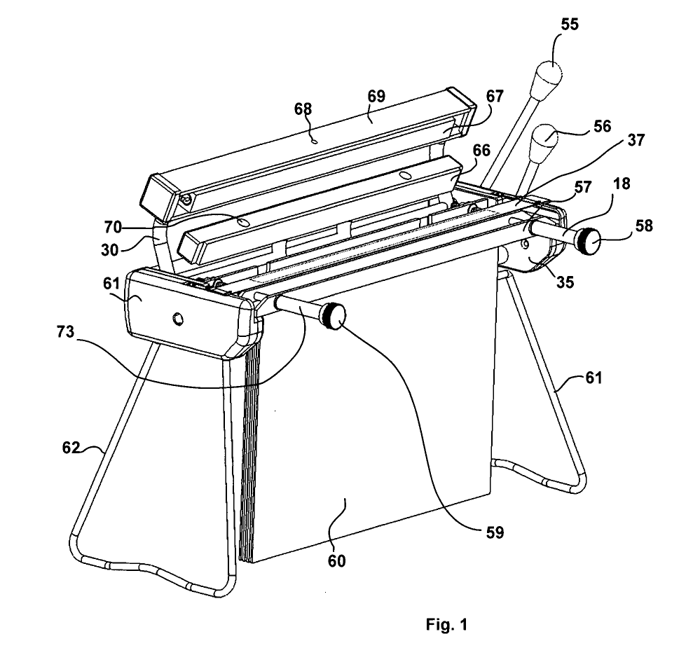

FIG. 1 shows an orthogonal view an assembled Binding Machine without the Document Stacking Base Housing which can also be used with it.

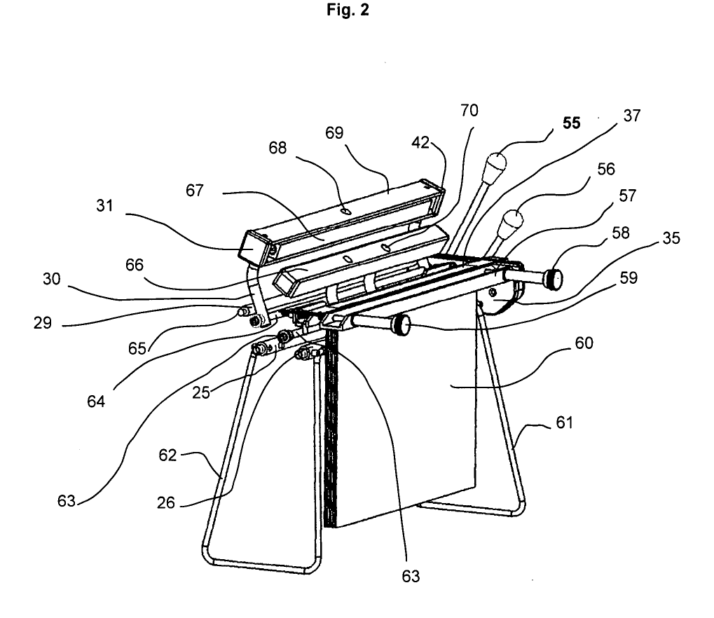

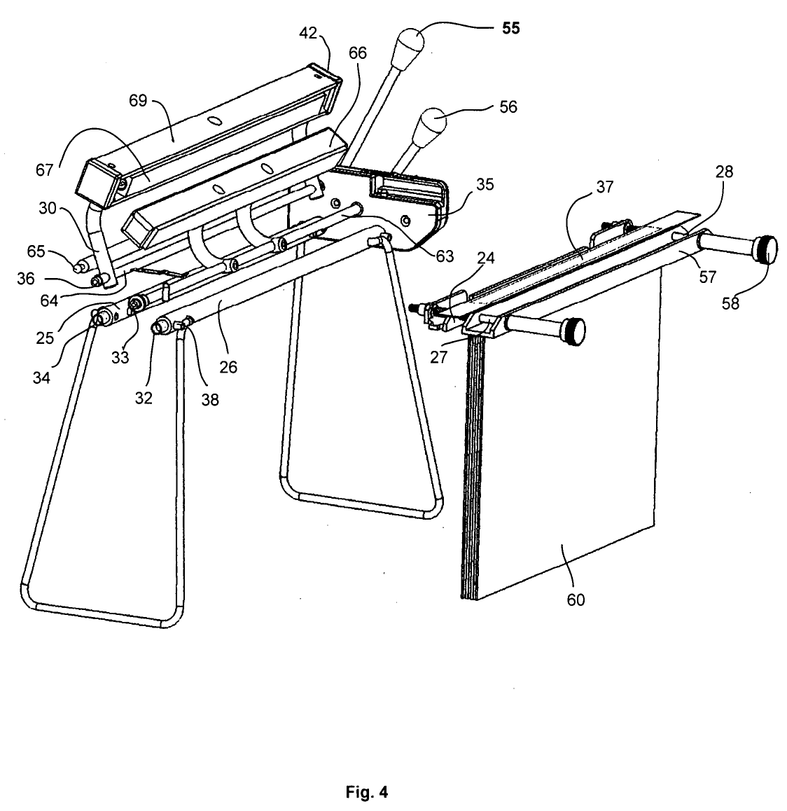

FIG. 2 shows an exploded perspective view of the machine with the Left Frame Cover (61) removed and a stack of documents ready to bind in it. A Paper Clamp Assembly comprised of a Front Paper Clamp (57), a Rear Paper Clamp (24) Shown in FIG. 2B, a Right Clamp Release Knob (58) and a Left Clamp Release Knob (59) holds a sheaf of papers or documents to be bound (60). The Heater Handle (55) which lowers the Heater Cover Housing (69) and the Cooling Element Handle (56) which raises and lowers the Cooling Element (66) can also be seen. The Cooling Element Handle (56) is connected to the Cooling Element (66) by the Cooling Element Pivot Shaft (63) in FIG. 4. The Cooling Element (66) also known as the Cooling Block in the preferred embodiment is a large block of metallic or other heat resistant material with the ability to act as a heat sink and rapidly diffuse heat from the Hot Melt Material after it has been heated. The Heater Cover Housing (69) is connected to the Heater Handle (55) by the left and Right Heating Arm Anchor (30), which rotates on the Heater Element Pivot Shaft (64) in FIG. 4. The Binding Machine sits upon a Right Folding Leg also known as a Right Collapsible Leg (61) and a Left Folding Leg also known as a Collapsible Leg (62). The Heater Element (67) is contained within the Heater Cover Housing (69). The Heater Cover Housing (69) in the preferred embodiment has a Left End Cap (31) and a Right End Cap (42) and contains a Heater Center Pin (68), which pivots to allow even pressure to be applied to the document being bound. In the preferred embodiment, the Heater Cover Housing (69) has a Left End Cap (31 and a Right End Cap (42) at each end. The Cooling Element (66) in the preferred embodiment, is anchored inside a Cooling Element Cover by two Cooling Arm Anchor Grommets (70) which anchor the Cooling Element (66) and the Cooling Element Cover over it to the Cooling Element Pivot Shaft (63) in FIG. 4. In the preferred embodiment, a Frame Support Rod (29) is anchored into place by the Right Frame Cover (35) on the right side. Also in the preferred embodiment, the Frame Support Rod (29) is anchored into both the Right Frame Cover (35) and the Left Frame Cover by a Frame Support Rod Button (65). The Front Main Frame Shaft (26) and the Rear Main Shaft (25) hold the frame together. The Thermal Strip, also known as a Hot Melt Strip, which is made of a Generic Hot Melt Adhesive (37), which will be fused onto the sheaf of documents (60), is also shown. The Hot Melt Strip (37) is placed on top of the Spine Edge of the document to be bound.

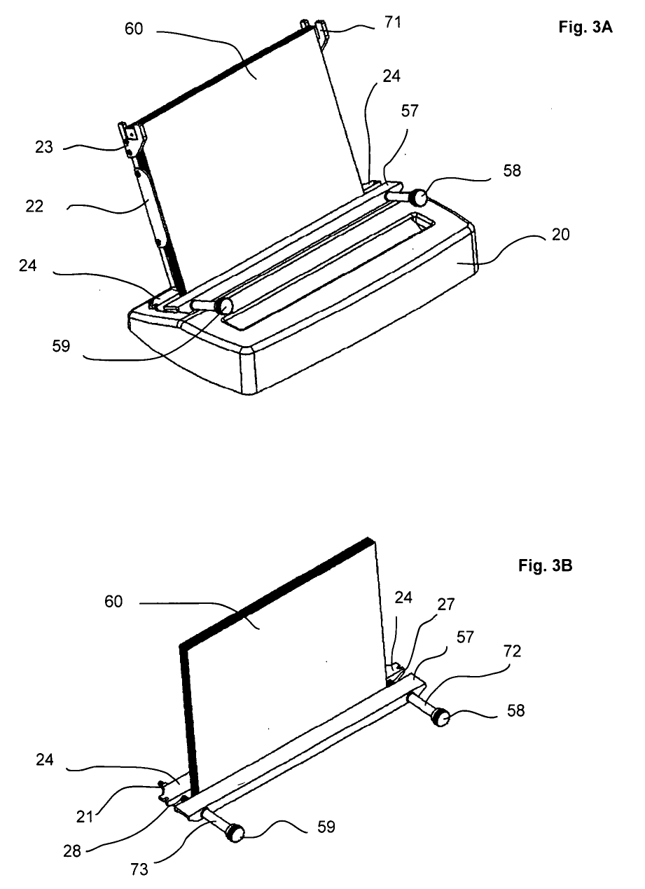

FIG. 3A: Shows a perspective view of a stack of documents (60) anchored together with a Paper Clamp Assembly. The housing comprising the Document Stacking Base (20) is shown with a sheaf of documents (60) being clamped between the Front Paper Clamp (57) and the Rear Paper Clamp (24). The Front Paper Clamp (57) and the Rear Paper Clamp (24) are kept tight by securing the Right Clamp Release Knob (58) and the Left Clamp Release Knob (59). A Right Side Cutter And Tape Guide (71) and a Left Side Cutter And Tape Guide (23) in conjunction with the Paper Stopper (22) assist in keeping the sheaf of documents properly stacked for binding.

FIG. 3B shows a perspective view of a stack of documents in the Paper Clamp Assembly after removal from the Document Stacking Base Housing (20) ready to be inserted into the Binding Machine. The Right Clamp Screw (27) and the Left Clamp Screw (28) secured and released by the Right Clamp Release Knob (58) and the Left Clamp Release Knob (59) via the Right Clamp Post (72) and Left Clamp Post (73) are also visible.

FIG. 4 shows an exploded perspective view of the Binding Machine with a stack of documents already in the Paper Clamp Assembly next to it. A Hot Melt Strip (37) composed of a generic Hot Melt adhesive material has already been applied to the stack of documents which is about to be inserted into the Binding Machine. In the preferred embodiment, the Front Main Frame Shaft Button (32), Cooling Element Pivot Shaft Button (33) Rear Main Frame Shaft Button (34) and Heater Element Pivot Shaft Button (36) all anchor into the Left Frame Cover (not shown). They also anchor on the right side into the Right Frame Cover (35). The Left Side Front Main Frame Shaft Anchor Pin (38) and Right Side Front Main Frame Shaft Anchor Pin (39) prevent the 5 Right Folding Leg (61) and Left Folding Leg (62) from opening too far when the portable Binding Machine is set up.

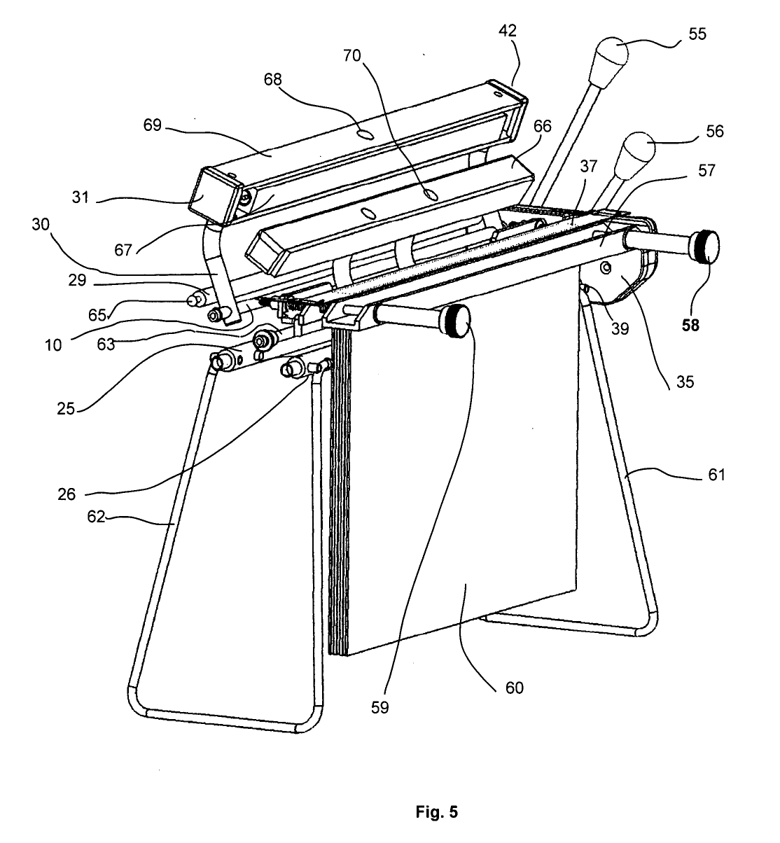

FIG. 5 shows a perspective view of the machine with the Thermal Strip placed on the spine of the book about to be heated by the Heater Element (67). The Heater Element (67) is above the Hot Melt Strip (37) in the open position. The Cooling Element 10 (66) can also be seen in the open position below the Heater Element (67).

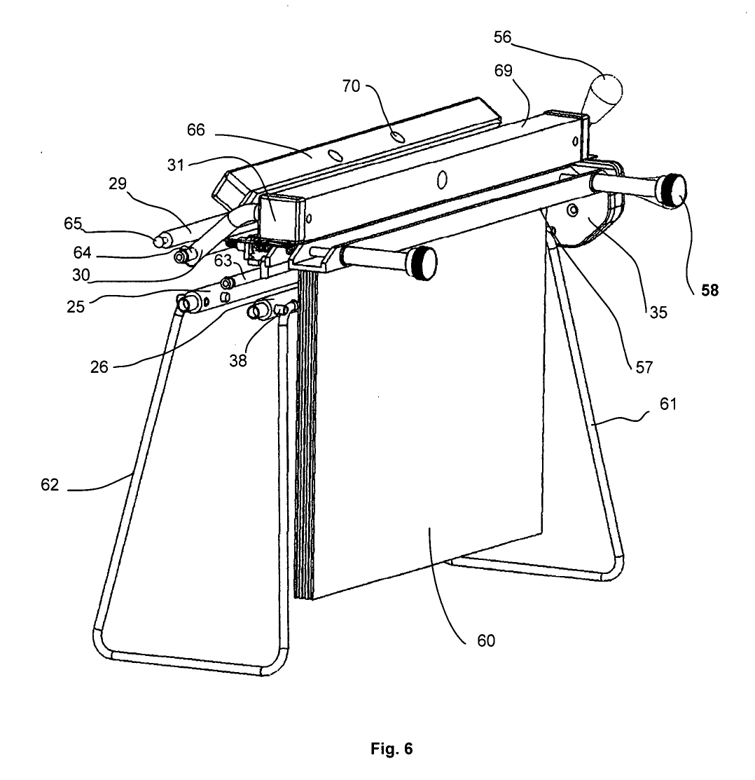

FIG. 6 shows a perspective view of the machine with the Heater Element inside the Heater Cover Housing (69) in the closed position over the Hot Strip material (37).

The Heater Element (67) then heats the Hot Melt Strip, causing the Hot Melt material to flow downward in between the sheets of the document (60), sealing their ends and 1 5 creating a sealed binding for the documents.

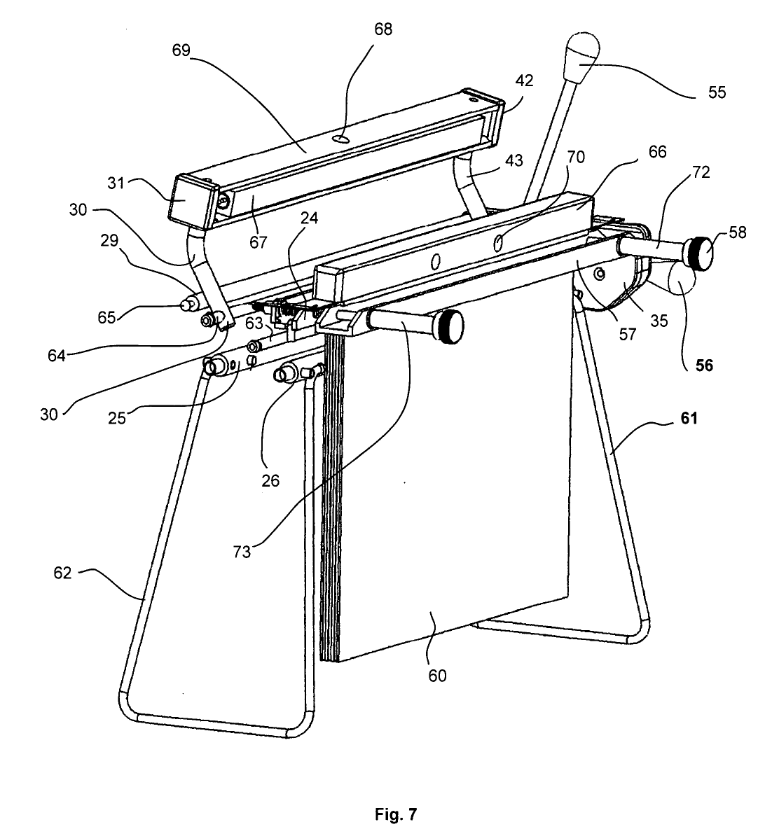

FIG. 7 shows a perspective view of the Heater Element (67) in the open position with the Cooling Element (66) in place over the Hot Melt Strip (37). The Right Heating Arm Anchor (43) can be seen next to the Heater Handle (55).

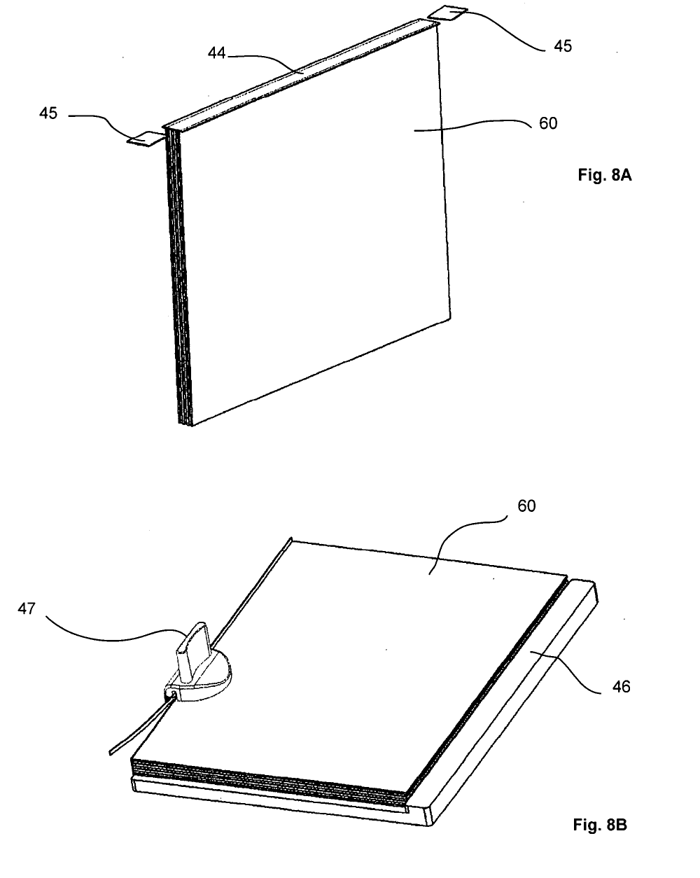

FIG. 8A shows a perspective view of the bound document (60) removed from 20 the Binding Machine. The document is now ready for both ends to have the excess portion of the Hot Melt Thermal Strip to be trimmed off and the Magic Tape Cutoff (45).

FIG. 8B shows a close up perspective view of the Thermal Strip Trimmer (47) in use to trim off the excess of the Thermal Strip composed of the Hot Melt material after binding. The Thermal Strip Trimmer can be seen near the lower part of the view removing a portion of excess Thermal Strip Hot Melt material from the document (60). A Document Stop (46) helps keep the document (60) steady during the trimming process.

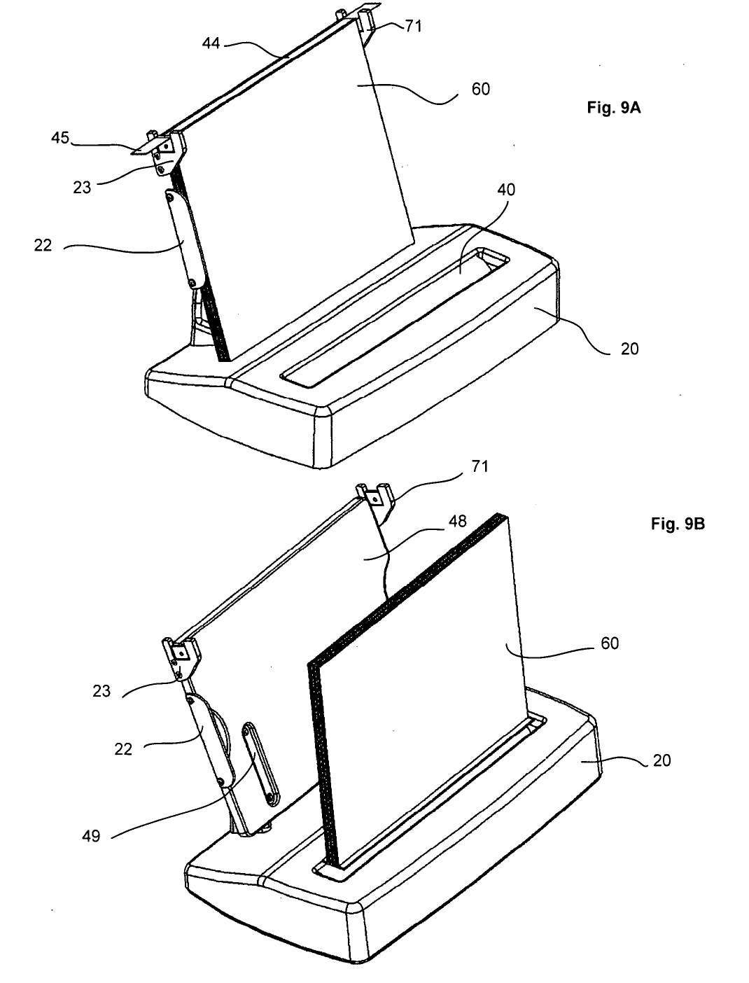

FIG. 9A shows a bound document pushed down into the Document Holder (20) with Binding Tape or clear “Magic” Tape (44) applied to the spine. The paperback panel (48) is used to support the document when it is being prepared for the Binding Tape or Magic Tape (44) to be applied. It is also used when cutting off the excess Binding Tape or Magic Tape (71) from both ends of the document being bound. The paperback panel recess (49) allows the size of the paperback panel (48) to be adjusted to fit varying sizes of documents to be bound.

FIG. 9B shows a bound document pushed down into the Document Tape Press Slot (40) to fold the tape applied previously to the spine.

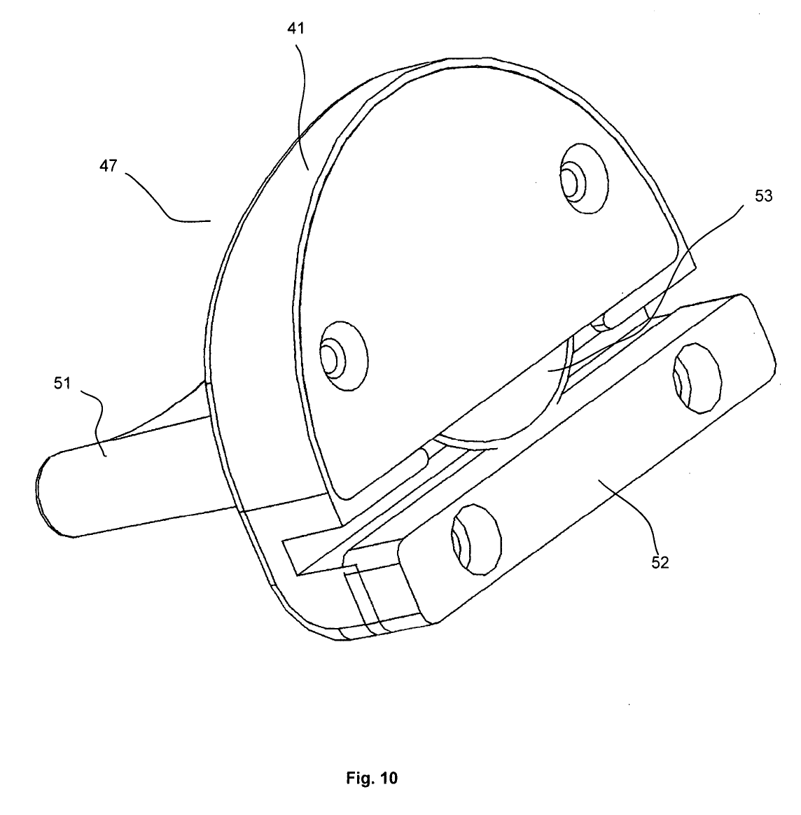

FIG. 10: Shows a close up perspective view of the Thermal Strip Trimmer (47) used to trim off the excess of the Thermal Strip composed of the Hot Melt material after binding. The Thermal Strip Trimmer is comprised of a Trimmer Housing (41), a Trimmer Blade (53) and a Trimmer Blade Stop (52). The Trimmer is manipulated by the operator using the Trimmer Handle (51).

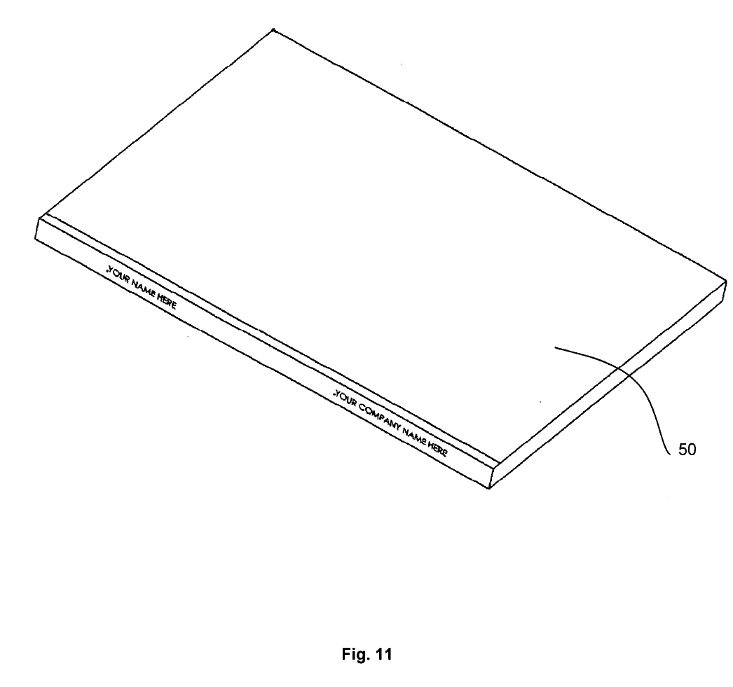

FIG. 11 shows a Bound Document (50) ready for use.

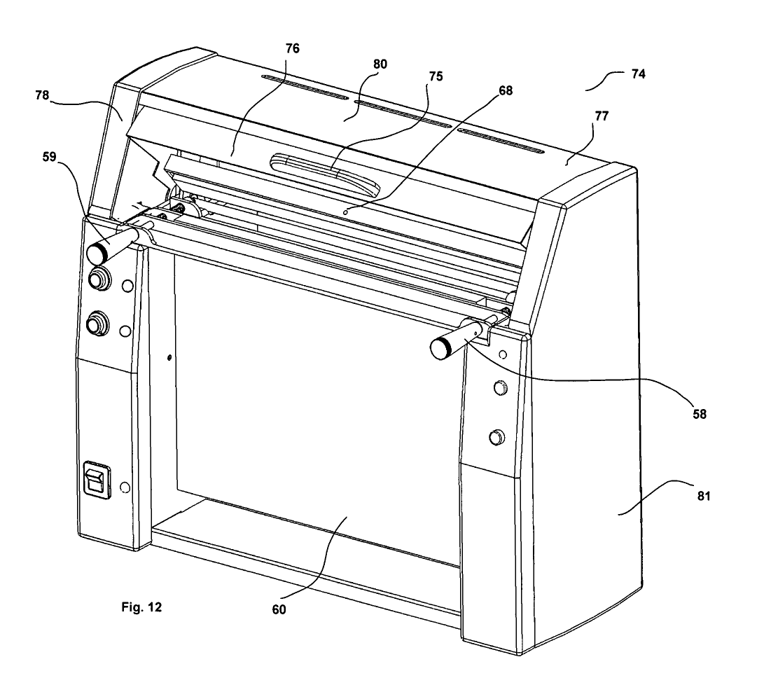

FIG. 12 shows a perspective view of another embodiment of the invention using a motor means (74) to open and close the heating and cooling Elements instead of hand actuated levers. The Front Paper Clamp attached to the Left Clamp Release Knob (59), the Right Clamp Release Knob (58), the Document being Bound (60), and Heater Center Pin (68), are still visible inside the invention. The motor means and other mechanical parts in this embodiment are enclosed by a Right Side Cover Panel (81), a Left Side Cover Panel (78), a Top Panel (80), and a Sliding Cover (76) operated by a Sliding Cover Handle (75). Although the legs do not fold up, the configuration of the frame, heating and cooling means still make this machine very portable.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

I claim:

1. A portable document binding machine comprising:
(a) a heating element capable of melting a hot melt strip;
(b) a cooling element capable of cooling a melted hot melt strip;
(c) a paper clamp means to hold a sheave of documents to be bound;
(d) a frame to anchor the paper clamp, the heating element and the cooling element into position;
(e) a plurality of collapsible legs to support the frame;
(f) a thermal strip composed of a generic hot melt adhesive material;
(g) a means to alternately place the heating and cooling elements on top of the thermal strip when it is placed on top of the spine edge of a sheave of documents held in place in the machine by the paper clamp.

2. A kit for binding documents comprising the machine in claim 1 and:
(a) a thermal strip trimmer;
(b) a trimming board used to trim off the excess thermal strip hot melt material after binding;
(c) a means for placing binding tape over the melted hot strip material;
(d) a means to push the bound document down into a cavity to fold the binding tape over the spine.

3. A method of binding a document comprising:
(a) a binding machine comprising:
(i) a heating element capable of melting a hot melt strip;
(ii) a cooling element capable of cooling a melted hot melt strip;
(iii) a paper clamp means to hold a sheave of documents to be bound;
(iv) a frame to anchor the paper clamp, the heating element and the cooling element into position;
(v) a plurality of collapsible legs to support the frame;
(vi) a thermal strip composed of a generic hot melt adhesive material;
(vii) a means to alternately place the heating and cooling elements on top of the thermal strip when it is placed on top of the spine edge of a sheave of documents held in place in the machine by the paper clamp;
(b) the method steps comprising:
(i) warming up the heating element to a sufficient temperature to melt the thermal strip;
(ii) aligning the pages to be bound into a single document;
(iii) after aligning the pages to be bound into a single document, securing the single document with a paper clamp means;
(iv) attaching the paper clamp means with the sheave of documents in it to the machine;
(v) applying a thermal strip to the spine edge of the document to be bound;
(vi) applying the hot heating element to the thermal strip;
(vii) allowing the thermal strip material to flow downward in between the pages of the document;
(viii) placing the cooling pad over the thermal strip;
(ix) removing the cooling pad from the thermal strip.
(x) removing the bound document from the paper clamp.

4. The method in claim 3 wherein the thermal strip is applied to the spine edge of the document to be bound before the paper clamp is inserted into the machine.

5. The method in claim 3 wherein after removing the paper clamp from the machine with the bound documents in it, the binding of the document is completed by:
(a) trimming of the excess thermal strip from the ends of the document placed on a trimming board with a thermal strip trimmer;
(b) applying binding tape to the spine of the document;
(c) pushing the document down into a receptacle cavity sized to fold the binding tape over the spine of the document being bound.

6. The Machine in claim 1 wherein the heating element is capable of heating the thermal strip on the spine edge of the document to approximately 175 degrees Fahrenheit for approximately 2 to 3 minutes.

7. The method in claim 3 wherein the thermal strip on the spine edge of the document is heated to approximately 175 degrees Fahrenheit until the thermal strip has melted over the documents to be bound.

8. The method for binding a document in claim 5 wherein after the bound document has been removed from the machine and binding tape has been applied, but before pushing the document into a receptacle sized cavity, a strip of clear tape is placed over the binding tape.

9. The portable document binding machine of claim 1 wherein the heating element and cooling element are moved by a motorized means to apply heating and cooling to the thermal strip on top of the spine edge of the document.

10. The method of claim 3 wherein the heating element and cooling element are moved by a motorized means to apply heating and cooling to the thermal strip on top of the spine edge of the document.

11. The machine in claim 1 wherein:
(a) the heating element is inside a heater cover;
(b) the cooling element is inside a cooling element cover;
(c) the paper clamp means to hold a sheave of documents to be bound is comprised of a front paper clamp and a rear paper clamp, the left side of the clamp means being connected by a left clamp post secured by a left clamp release knob on the left and the right side of the clamp means being connected by a right clamp post secured by a right clamp release knob and;
(d) the frame to anchor the paper clamp, the heating element and the cooling element into position, is comprised of a right frame cover and a left frame cover held together by a front main frame rod and a rear main rod, each anchored into place by a frame support rod button;
(e) there is a plurality of collapsible legs on the left side of the frame and a plurality of collapsible legs on the right side of the frame to support the frame.

12. The portable document binding machine of claim 11 wherein the heater cover housing is connected to the heater by a center pin which pivots to allow even pressure to be applied to the document being bound.
